(19) United States
(12) Patent Application Publication
(10) Pub. No.: US 2026/0357891 A1
(43) Pub. Date: Nov. 12, 2026

(54) METHOD AND CONTROL UNIT FOR OPERATING A MOTOR VEHICLE TRANSMISSION

(71) Applicant: ZF Friedrichshafen AG, Friedrichshafen (DE)

(72) Inventors: Daniel Müller, Friedrichshafen (DE); Martin Fimpel, Leutkirch (DE)

(73) Assignee: ZF Friedrichshafen AG, Friedrichshafen (DE)

(21) Appl. No.: 19/673,785

(22) Filed: May 11, 2026

(30) Foreign Application Priority Data
May 12, 2025 (DE) 10 2025 118 051.2

(51) Int. Cl. F16H 61/12; F16H 59/40; F16H 59/42; F16H 59/68

(52) U.S. Cl. CPC F16H 61/12; F16H 59/40; F16H 59/42; F16H 59/68; F16H 2059/405; F16H 2059/425; F16H 2061/1224

(57) ABSTRACT

A motor vehicle transmission has shifting elements actuated by electric actuating currents applied to pressure actuators. In an engaged gear, the transmission defines a first number of shifting elements actuated to closed and a second number of shifting elements actuated to open. Based on the electric actuating currents, the number of shifting elements actuated to close is monitored. Checking whether the transmission is incorrectly braced is based whether the number of shifting elements actuated to closed is larger than the defined first number of shifting elements. Further, a method monitors a first rotation speed gradient of a transmission input rotation speed (or corresponding rotation speed), and a second rotation speed gradient of a transmission output rotation speed (or corresponding rotation speed). Checking whether the transmission is incorrectly braced considers the number of shifting elements actuated to closed and the first and second time-related rotation speed gradients.

### RELATED APPLICATIONS

This application claims the benefit of and right of priority under 35 U.S.C. § 119 to German Patent Application no. 10 2025 118 051.2, filed on 12 May 2025, the contents of which are incorporated herein by reference in its entirety.

### FIELD OF THE DISCLOSURE

The invention relates to a method and control unit for operating a motor vehicle transmission.

### BACKGROUND

A powertrain of a motor vehicle comprises a drive aggregate and a transmission connected between the drive aggregate and a drive output. The transmission converts rotation speeds and torques and thereby determines the traction force provision at the drive output.

Motor vehicle transmissions known from the prior art, which provide a plurality of gears, comprise a number of shifting elements. The shifting elements of the transmission can be interlocking shifting elements such as claws, and/or frictional shifting elements such as clutches or brakes.

In each engaged frictional gear of a transmission, a first defined number of shifting elements of the transmission are actuated to close them, and a second defined number of the transmission shifting elements are actuated to open them. When carrying out a gearshift from a current gear to a target gear of the transmission, at least one shifting element which is closed in the current gear is actuated to open it, and in addition at least one other gear which is open in the current gear is actuated to close it.

In order to actuate a shifting element of a transmission to close it, a pressure actuator of the shifting element concerned is acted upon by an electric actuating current, which in relation to its time duration is such that as the result of the actuation the shifting element closes in a defined manner. The shifting elements of a transmission are prone to wear. The result of such shifting element wear can be that the duration of an actuating current which should close the shifting element concerned is no longer sufficient to close the shifting element in the required manner. Consequently, it is already known from the prior art to adapt actuating currents for the closing of shifting elements.

To adapt an actuating current that serves to close a shifting element of a transmission, the procedure is that when in the transmission a gear is engaged in which the shifting element whose actuating current has to be adapted is open, then to close the shifting element it is actuated with a defined increase of the actuating current until, on the basis of the monitoring of a transmission input rotation speed or of a rotation speed that corresponds to the transmission input rotation speed and/or on the basis of the monitoring of a transmission output rotation speed or of a rotation speed that corresponds to the transmission output rotation speed, it is recognized that the shifting element being actuated for its closure is beginning to transmit torque. Thereby the actuating current for the shifting element concerned can be adapted step by step, namely increased step by step, and this can be increased at most up to a maximum permissible adaptation value which is stored in a control unit.

In practice it is not possible to increase an actuating current above the maximum permissible adaptation value which is stored in the control unit. As a result, it can happen that optimum shifting quality cannot be ensured over the lifetime of a transmission, namely if owing to wear the actuating current adapted to its maximum extent is still insufficient to close the shifting element concerned to the extent required.

In transmissions known from practice this restriction of the adaptation of an actuating current of a particular transmission shifting element to the maximum permitted adaptation value stored in the control unit is also based on the fact that according to practice the monitoring of an incorrectly braced transmission takes place exclusively with reference to the monitoring of the actuating current of the shifting element. Thus, in practice, if for a defined time period a number of shifting elements of the transmission are actuated to close them, which number is larger than the first-defined number of shifting elements, then in practice it is concluded that the transmission is incorrectly braced. Thus, there is a need to be able to operate a transmission over a longer operating period while ensuring optimum shifting quality. Furthermore, a method is needed for checking whether a transmission is incorrectly braced, to enable this.

From DE 10 2018 219 493 A1 and DE 10 2018 220 168 A1 methods for the adaptation of parameters of a transmission are known.

### SUMMARY

Starting from there, the purpose of the present invention is to provide a new type of method and control unit for operating a transmission. This objective is achieved by methods and a control unit according to the present disclosure.

According to one example method, to check whether a transmission is incorrectly braced, in addition a first time-related rotation speed gradient of the transmission input rotation speed or of a rotation speed that corresponds to the transmission input rotation speed, and a second time-related rotation speed gradient of the transmission output rotation speed or of a rotation speed that corresponds to the transmission output rotation speed are monitored, and depending on the number of shifting elements actuated to close them and depending on the first time-related rotation speed gradient and the second time-related rotation speed gradient, it is checked whether there is an incorrectly braced transmission.

In that method, checking whether there is an incorrectly braced transmission is based not only on checking the number of shifting elements being actuated to close by their respective electric actuating currents, but also on an evaluation of time-related rotation speed gradients, namely, the first time-related rotation speed gradient of the transmission input rotation speed or of the rotation speed corresponding to the transmission input rotation speed, and the second time-related rotation speed gradient of the transmission output rotation speed or of the rotation speed corresponding to the transmission output rotation speed. It is then only concluded that the transmission is incorrectly braced if the first time-related rotation speed gradient or the second time-related rotation speed gradient, or both, is or are quantitatively larger than a respective limit value. In that way it is possible, particularly when adapting a number of shifting elements larger than the defined number of shifting elements, in relation to their respective electric actuating currents, to close them at the same time without an incorrectly braced transmission being recognized.

Preferably, the presence of an incorrectly braced transmission is concluded if the number of shifting elements actuated to close by their respective actuating currents is larger than the defined first number of shifting elements and if, moreover, the first time-related rotation speed gradient of the transmission input rotation speed or of the rotation speed corresponding to the transmission input rotation speed and/or the second time-related rotation speed gradient of the transmission output rotation speed or of the rotation speed corresponding to the transmission output rotation speed is/are quantitatively larger than a respective limit value. This preferably indicates the presence of an incorrectly braced transmission.

Preferably, to check whether the transmission is incorrectly braced, a driving situation of the motor vehicle is also monitored, such that if the number of shifting elements actuated to close at the same time by their respective actuating currents is larger than the defined first number of shifting elements and if, moreover, the first time-related rotation speed gradient of the transmission input rotation speed or of the rotation speed corresponding to the transmission input rotation speed and/or the second time-related rotation speed gradient of the transmission output rotation speed or of the rotation speed corresponding to the transmission output rotation speed is/are larger than a respective limit value, but if the first time-related gradient quantitatively larger than the respective limit value and/or the second time-related gradient quantitatively larger than the respective limit value is/are caused by the driving situation of the motor vehicle, then the presence of an incorrectly braced transmission is not concluded. If a quantitatively too large first time-related rotation speed gradient and/or a quantitatively too large second time-related rotation speed gradient is caused by a driving situation, for example by vigorous braking of the motor vehicle, the presence of an incorrectly braced transmission is not recognized.

Preferably, the presence of an incorrectly braced transmission is concluded if a period of time, in which the number of shifting elements actuated by their respective electric actuating currents to close them at the same time is larger than the defined first number of shifting elements, is longer than a respective limit value. In relation to the recognition of an incorrectly braced transmission this further development is preferred.

According to a second method, when, during the adaptation of a particular actuating current, the current has been increased up to the maximum permitted adaptation value, the maximum permitted adaptation value is increased step by step. Preferably, if when adapting the actuating current of a shifting element that is open in the gear engaged, the shifting element is actuated so as to close it, then by virtue of the first method discussed above, the recognition of an incorrectly braced transmission is prevented. With the second method it is possible, when adapting, to increase the maximum permitted adaptation value and thereby, thanks to a longer operating time of the transmission, to enable optimal shifting behavior in the transmission by virtue of an adaptation that compensates for wear of the shifting elements.

Preferably the actuating current for the shifting element concerned is adapted step by step in first step sizes, whereas the maximum permitted adaptation value is increased step by step in second step sizes. The first step size can correspond to the second step size. The second step size can also be larger than the first step size. That is particularly preferred for the adaptation.

### BRIEF DESCRIPTION OF THE DRAWINGS

Preferred further developments emerge from the dependent claims and the description that follows. Example embodiments of the invention, to which it is not limited, are explained in greater detail with reference to the drawing, which shows:

FIG. 1: An example of a powertrain of a motor vehicle,

FIG. 2: A first time diagram to clarify the invention,

FIG. 3: A second time diagram to clarify the invention, and

FIG. 4: A third time diagram to clarify the invention.

### DETAILED DESCRIPTION

FIG. 1 shows the principle of the structure of a powertrain of a motor vehicle. Thus, FIG. 1 shows a drive aggregate 10 and a drive output 11. Between the drive aggregate 10 and the drive output 11, in FIG. 1 a transmission 12 and a hydrodynamic starting element 13 are connected.

The hydrodynamic starting element 13 is optional, wherein the hydrodynamic starting element 13 in FIG. 1 comprises a converter 14 and a converter bridging clutch 15. Of the converter 14 a turbine wheel 16 and a pump wheel 17 are shown. As already stated, the hydrodynamic starting element 13 is an optional assembly.

The transmission 12 comprises a plurality of shifting elements 18. As an example, FIG. 1 shows a shifting element 18 in the form of a frictional shifting element, namely a clutch or brake. In addition to frictional shifting elements, a transmission can comprise at least one interlocking shifting element. In each engaged gear of the transmission 12, a first number of shifting elements 18 are closed and a second number of shifting elements 18 are open.

In addition, FIG. 1 shows a motor control unit 19 for controlling and/or regulating the operation of the drive aggregate 10, and a transmission control unit 20 for controlling and/or regulating the operation of the transmission 12 and in FIG. 1 also the operation of the hydrodynamic starting element 13. According to FIG. 1, the respective control unit 19, 20 exchanges data with the assembly to be controlled and/or regulated by the control unit 19, 20 concerned. Furthermore, the motor control unit 19 and the transmission control unit 20 exchange data with one another.

If a gearshift is to be carried out between a current gear and a target gear, then a shifting element 18 which is closed in the current gear is actuated to open it and a shifting element 18 which is open in the current gear is actuated to close it.

The actuation of a shifting element 18 to close it takes place by virtue of a defined electric actuating current which, for a defined time, actuates a pressure actuator of the shifting element 18 concerned in such manner that by means of the pressure actuator a pressure variation necessary for closing the shifting element 18 is produced.

On the basis of the electric actuating current for the shifting element 18 of the transmission 12, it can be checked whether there is an incorrectly braced transmission 12.

According to the invention, to check whether there is an incorrectly braced transmission 12, in addition to the electric actuating current, a first time-related rotation speed gradient of a transmission input rotation speed of the transmission 12 or of a rotation speed corresponding to the transmission input rotation speed and a second time-related rotation speed gradient of a transmission output rotation speed of the transmission 12 or of a rotation speed corresponding to the transmission output rotation speed are monitored, and depending on the number of shifting elements actuated to close them and depending on the first time-related rotation speed gradient and the second time-related rotation speed gradient, it is checked whether there is an incorrectly braced transmission 12. In FIG. 1 the transmission input rotation speed is the rotation speed of the turbine wheel 16.

Thus, in particular, it is concluded that the transmission 12 is incorrectly braced if the number of shifting elements 18 actuated to close them by means of their respective electric actuating currents is larger than the defined first number of shifting elements and when, moreover, the first time-related rotation speed gradient and/or the second time-related rotation speed gradient is/are quantitatively larger than a respective limit value.

In this connection, it is in particular provided that an incorrectly braced transmission 12 exists if a time duration, in which the number of shifting elements 18 actuated to close them at the same time by means of their respective electric actuating currents is larger than the defined first number of shifting elements 18, is longer than a particular limit value, and this also even if the first time-related rotation speed gradient and the second time-related rotation speed gradient are smaller than their respective limit values. Accordingly, for a defined maximum time duration it is permitted to actuate a number of shifting elements 18 of the transmission 12 so as to close them at the same time, which number is larger than the first number of shifting elements 18, without concluding the presence of an incorrectly braced transmission 12. But if within the defined maximum time duration the first rotation speed gradient and/or the second rotation speed gradient is or becomes quantitatively larger than a respective limit value, then the presence of an incorrectly braced transmission 12 is concluded. The first number of shifting elements 18 is that number of shifting elements 18 which are actuated to close then at the same time in an engaged gear.

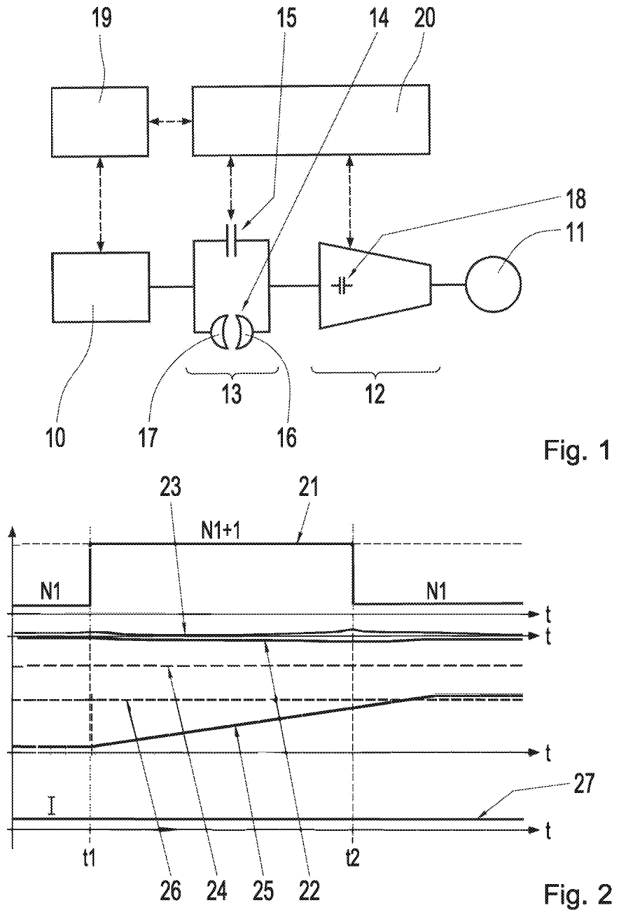

These relationships are described in what follows with reference to FIGS. 2 to 4, wherein in FIGS. 2 to 4 a number of time-related curve variations are shown as a function of time t.

The time-related curve 21 shows the number of shifting elements 18 actuated by their actuating currents to close at the same time, such that before the time-point t1 and after the time-point t2 a number of shifting elements is actuated to close them at the same time, which number corresponds to the defined first number NI of shifting elements which when a gear is frictionally engaged are actuated to close them at the same time. Between the time-points t1 and t2 the number of shifting elements 18 actuated to close them at the same time is N1+1, i.e. larger by 1 than the defined first number N1. The curve 22 corresponds to the time variation of the first time-related rotation speed gradient of the transmission input rotation speed or the time variation of the rotation speed that corresponds to the transmission input rotation speed. The curve 23 corresponds to the time variation of the second time-related rotation speed gradient of the transmission output rotation speed or the rotation speed that corresponds to the transmission output rotation speed. In addition FIG, 2 shows a limit value 24 for the first time-related rotation speed gradient of the transmission input rotation speed (or the speed corresponding thereto), and the second time-related rotation speed gradient of the transmission input speed (or the speed corresponding thereto). In the example embodiment shown, a common limit value 24 is stored for the first time-related rotation speed gradient and for the second time-related rotation speed gradient. Furthermore, FIG. 2 shows a curve 25 which corresponds to the variation of a timer started at time t1, i.e. when at time t1, on the basis of the actuating currents, it is recognized that a number of shifting elements 18 of the transmission 12 are actuated to close them at the same time, which number is larger than the first number N1. Moreover, FIG. 2 shows a limit value 26 for the timer. The curve 27 in FIG. 2 represents a status signal which corresponds in condition I to a condition in which a transmission 12 that is not incorrectly braced is concluded, and which corresponds in condition II to a condition in which an incorrectly braced transmission 12 is concluded.

Thus, in FIG. 2 between time-points t1 and t2, by virtue of their actuating currents a number N1+1 of shifting elements 18 of the transmission 12 are actuated to close them at the same time, which number is larger than the first number N1 of shifting elements which are in themselves actuated in an engaged gear to close them, so that in FIG. 2 neither the first time-related rotation speed gradient 22 of the transmission input rotation speed (or of the rotation speed corresponding to the transmission input speed), nor the second time-related rotation speed gradient 23 of the transmission input speed (or of the speed corresponding to the transmission input speed) exceeds the limit value 24 in absolute magnitude, nor has the timer 25 reached the limit value 26. Accordingly, in FIG. 2 despite the simultaneous actuation of the number N1+1 of shifting elements 18 of the transmission 12, which is larger than the first number N1, no incorrectly braced transmission 12 is concluded.

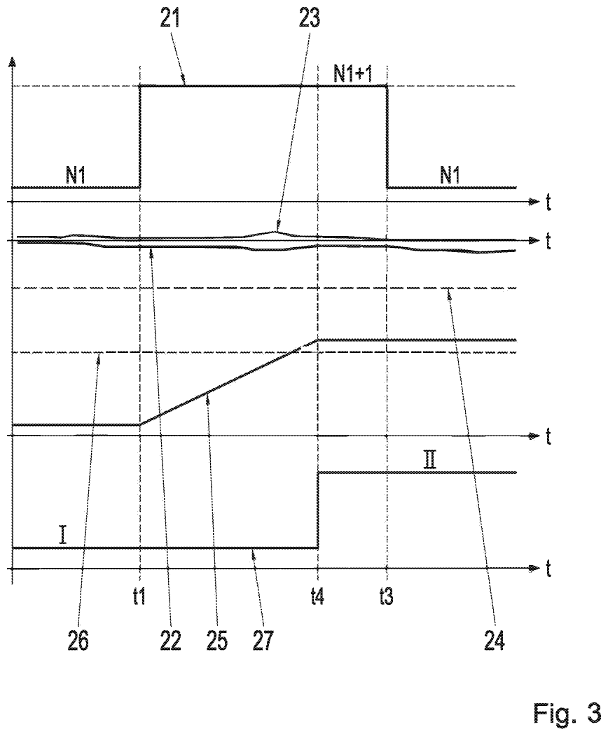

In contrast, FIG. 3 shows the above-mentioned time variations 21, 22, 23, 25 and 27 in a situation in which, between time points t1 and t2, by virtue of their actuating currents again a number N1+1 of shifting elements 18 of the transmission 12 are actuated at the same time to close them, which number is larger than the number N1 and in which the two time-related rotation speed gradients 22, 23 are quantitatively not greater than the limit value 24, although in FIG. 3 at time-point t4 it is recognized that the timer 25 has gone beyond its limit value 26, so that the time duration, in which the number of shifting elements 18 actuated simultaneously to close them is larger than the defined number NI, is longer than the limit value 26. Accordingly, at time-point t4, in accordance with the condition II of the variation curve 27, the presence of an incorrectly braced transmission 12 is concluded.

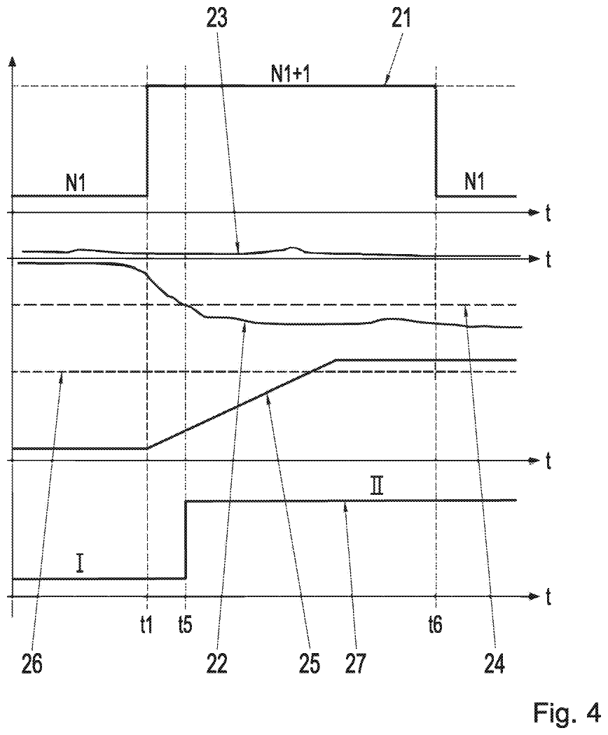

FIG. 4 shows the variation curves 21 to 27 in a situation in which, between time-points t1 and t6, by virtue of their actuating currents again a number N1+1 of shifting elements 18 of the transmission 12 are actuated at the same time to close them, which number is larger than the number N1 and in which, at time-point t5, it is recognized that the first time-related rotation speed gradient 22 of the transmission input rotation speed or of the rotation speed that corresponds to the transmission input rotation speed is larger than the limit value 24, so that in FIG. 4, at time-point t5, in accordance with the signal variation 27 an incorrectly braced transmission 12 is concluded and the status signal 27 changes from condition I to condition II.

Thus, the present invention proposes a completely new type of method for monitoring whether, when a plurality of shifting elements 18 of a transmission 12 are actuated to close them at the same time, an incorrectly braced transmission 12 is produced. This check is based not only on the number of shifting elements 18 of the transmission 12 actuated simultaneously by their actuating currents to close them, but also on monitoring of the first time-related rotation speed gradient 22 of the transmission input rotation speed or of the rotation speed that corresponds to the transmission input rotation speed and of the second time-related rotation speed gradient 23 of the transmission output rotation speed or of the rotation speed that corresponds to the transmission output rotation speed, and preferably also monitoring of a maximum permitted time duration for which a number of shifting elements 18 of the transmission 12 are actuated simultaneously by means of their actuating currents to close them, the number being larger than the defined first number of shifting elements 18 actuated to close in a frictionally engaged gear.

The invention relates not only to checking whether there is an incorrectly braced transmission 12, but also to the adaptation of the transmission 12, namely the adaptation of actuating currents for actuators of the shifting elements 18 of the transmission 12, with which the shifting elements 18 of the transmission 12 are actuated to close them. For adaptation, the procedure is that when the motor vehicle is driving with a frictional gear in the transmission 12 for which the defined first number N1 of shifting elements 18 are actuated to close them, in addition a further shifting element 18 to be adapted is actuated to close it. This shifting element 18 to be adapted is actuated to close it for as long as, on the basis of monitoring the transmission input rotation speed or of the rotation speed that corresponds to the transmission input rotation speed and/or on the basis of monitoring the transmission output rotation speed or of the rotation speed that corresponds to the transmission output rotation speed, it is recognized that the shifting element 18 of the transmission 12 actuated to close it for the adaptation is beginning to transmit torque.

Depending on this monitored actuation duration, the duration of the actuating current can be adapted in steps, namely increased, and this respectively with a defined first step size and indeed at most up to a maximum permitted adaptation value.

In the context of the invention, when during the adaptation a particular actuating current of a specific shifting element 18 of the transmission 12 has been increased to the maximum permitted adaptation value, i.e. the time duration of the actuating current has been increased to the maximum permitted adaptation value, the maximum permitted adaptation value is increased in steps and this with a second step size, whereby the adaptation limits can be extended and in the case when the wear of a shifting element 18 is severe optimum shifting quality can be ensured by a corresponding adaptation of the actuating current as before. In this case, with the method that serves for monitoring whether there is an incorrectly braced transmission, it is ensured that that during adaptation an incorrectly braced transmission 12 is recognized. It is then possible to operate a transmission 12 of a motor vehicle over a longer time while achieving optimum shifting quality, namely by extending the adaptation limits for the shifting elements 18 of the transmission 12, wherein the adaptation prevents recognition of an incorrectly braced transmission 12.

The first step size can correspond to the second step size. The second step size can also be larger than the first step size.

The above-described methods are used particularly with frictional shifting elements of a transmission 12.

The invention also relates to a control unit for operating a motor vehicle with a transmission 12. The control unit is designed to carry out the method described above. This control unit is in particular the transmission control unit 20. The transmission control unit 20 is an electronic control unit which comprises hardware means and software means for carrying out the method according to the invention.

The hardware means include data interfaces in order to exchange data with the assemblies involved in carrying out the method according to the invention. The hardware means also includes a processor for data processing and a memory for data storage. The software means includes program modules which are implemented in the control unit for carrying out the method according to the invention.

### INDEXES

10 Drive aggregate
11 Drive output
12 Transmission
13 Hydrodynamic starting element
14 Converter
15 Converter bridging clutch
16 Turbine wheel
17 Pump wheel
18 Shifting element
19 Motor control unit
20 Transmission control unit
21 Number of shifting elements actuated to close them
22 First time-related rotation speed gradient
23 Second time-related rotation speed gradient
24 Limit value for a rotation speed gradient
25 Timer
26 Limit value for the timer
27 Status signal for an incorrectly braced transmission

1-10. (canceled)

11. A method for operating a transmission (12) of a motor vehicle, wherein the transmission (12) comprises a plurality of shifting elements (18) configured to be actuated by means of electric actuating currents provided to pressure actuators of the shifting elements, wherein an engaged gear has a defined first number of shifting elements (18) actuated to a closed position and a defined second number of shifting elements (18) actuated to an open position, the method comprising:
determining, on the basis of the electric actuating currents, a number of the plurality of shifting elements (18) actuated to a closed position;
determining whether the number of the plurality of shifting elements (18) actuated to the closed position is larger than the defined first number of shifting elements (18);
determining a first time-related rotation speed gradient of a transmission input rotation speed or of a rotation speed corresponding thereto;
determining a second time-related rotation speed gradient of a transmission output rotation speed or of a rotation speed corresponding thereto; and
determining whether an incorrectly braced transmission exists based on (i) the number of shifting elements actuated to the closed position, (ii) the first time-related rotation speed gradient, and (iii) the second time-related rotation speed gradient.

12. The method according to claim 11, comprising
determining that number of shifting elements (18) actuated to the closed position exceeds the defined first number of shifting elements (18);
determining that the first time-related rotation speed gradient of the transmission input rotation speed or of the rotation speed corresponding thereto, and/or that the second time-related rotation speed gradient of the transmission output rotation speed or of the rotation speed corresponding thereto exceeds a respective limit value; and
concluding that an incorrectly braced transmission (12) exists.

13. The method according to claim 12, comprising:
monitoring a driving situation; and
concluding that the incorrectly braced transmission (12) exists based at least in part on the driving situation.

14. The method according to claim 11, comprising:
determining that the number of shifting elements (18) actuated to the closed position exceeds the defined first number of shifting elements (18);
determining that the first time-related rotation speed gradient of the transmission input rotation speed or of the rotation speed corresponding thereto, and/or that the second time-related rotation speed gradient of the transmission output rotation speed or of the rotation speed corresponding thereto exceeds a respective limit value;
determining that the first time-related rotation speed is exceeds the respective limit value, and/or the second time-related rotation speed exceeds the respective limit value for reasons relating to the driving situation of the motor vehicle; and
concluding that the incorrectly braced transmission (12) does not exist.

15. The method according to claim 11, comprising:
determining that a time duration during which the number of shifting elements (18) actuated to the closed position is greater than the defined first number of shifting elements (18);
determining that the time duration is longer than a particular limit value; and
concluding that the incorrectly braced transmission exists.

16. A method for operating a transmission (12) of a motor vehicle, wherein the transmission (12) comprises a plurality of shifting elements (1) configured to be actuated by means of electric actuating currents applied to pressure actuators, wherein for an engaged gear the transmission has a defined first number of shifting elements (18) actuated to a closed position and a defined second number of shifting elements (18) actuated to an open position, the method comprising:
engaging a gear in the transmission (12);
adapting the actuating currents by actuating, for a particular shifting element (18) that is open for the gear, the particular shifting element (18) to the closed position;
determining that the particular shifting element actuated to the closed position for adapting the actuating currents is beginning to transmit torque based on monitoring a transmission input rotation speed or of a rotation speed corresponding thereto, and/or based on monitoring a transmission output rotation speed or of a rotation speed corresponding thereto;
further adapting the actuating currents on a step-by-step basis for the particular shifting element at most up to a maximum permitted adaptation value;
determining during adaptation that an actuating current has been increased up to the maximum permitted adaptation value; and
increasing the maximum permitted adaptation value on a step-by-step basis.

17. The method according to claim 16, wherein the actuating current for the particular shifting element (18) is adapted in steps of a first step size, and wherein the maximum permitted adaptation value is increased in steps of a second step size.

18. The method according to claim 17, wherein first step size corresponds to the second step size or the second step size is larger than the first step size.

19. The method according to claim 16, comprising:
preventing concluding that an incorrectly braced transmission (12) is recognized, wherein when adapting the actuating current of a shifting element (18) that is open when the gear is engaged, the shifting element is actuated to close it according to the method of claim 1.

20. A control unit for operating a motor vehicle with a transmission (12), wherein the control unit is configured to carry out the method according to claim 11.
